(19) United States
(12) Patent Application Publication
(10) Pub. No.: US 2012/0215889 A1
(43) Pub. Date: Aug. 23, 2012

(54) COMMUNICATION TERMINAL DEVICE AND CONTENT DATA RECEIVING METHOD

(75) Inventor: Yasuaki Iwata, Kanagawa (JP)

(73) Assignee: Panasonic Corporation, Osaka (JP)

(21) Appl. No.: 13/504,059

(22) PCT Filed: Oct. 29, 2010
(86) PCT No.: PCT/JP2010/006399

§ 371 Date: Apr. 25, 2012

(30) Foreign Application Priority Data
Oct. 30, 2009 (JP) 2009-250426

(51) Int. Cl. G06F 15/16

(52) U.S. Cl. 709/217

(57) ABSTRACT

Disclosed is a communication terminal device whereby a user's perception of a wait time can be lessened while missing data portions are downloaded, and whereby the user becomes irritated less. In this device, a broadcast wave receiver (102) receives content data via a broadcast network and an antenna (101). An analysis unit (103) detects the missing portions of the content data and calculates the volume of the missing data portions. On basis of the calculated data volume, a communication unit (108) downloads the missing data portions via an antenna (107) and a communication network other than the broadcast network.

### TECHNICAL FIELD

The present invention relates to a communication terminal apparatus and a content data receiving method for receiving content data according to, for example, ISDB-Tmm (Integrated Services Digital Broadcasting Terrestrial Mobile Multi-Media Broadcasting) method.

### BACKGROUND ART

A broadcasting service called “one-segment” has been provided as a service for mobile receivers. For example, service for fixed receivers is transmitted using 12 segments among 13 segments constituting a frequency band for the Digital Terrestrial Broadcasting, and the remaining one segment is used to broadcast “one-segment”. This “one-segment” is a Digital Terrestrial Broadcasting Service using ISDB-T (Integrated Services Digital Broadcasting for Terrestrial) method (for example, see Patent Literature 1).

Instead of “one-segment”, next-generation mobile multimedia broadcast using ISDB-Tmm method obtained by expanding the ISDB-T has been suggested in recent years.

The multimedia broadcast using the ISDB-Tmm provides not only the same real-time broadcasting service as “one-segment” but also accumulation-type broadcasting service. The multimedia service using the ISDB-Tmm is a service for seamlessly providing a viewer with contents retrieved in real-time and contents accumulated in an accumulation apparatus. For example, a large amount of content data are accumulated in a reception apparatus in advance, and when content data that can be seen in real-time are transmitted later, the contents are associated with each other using metadata. By this means, the accumulated contents and the content that can be seen in real-time can be provided seamlessly to the viewers.

In the multimedia broadcasting using the ISDB-Tmm, when a plurality of defects occur in content data obtained from the real-time broadcasting service, data in the plurality of defect portions can be downloaded using the accumulation-type broadcasting service instead of the real-time broadcasting service.

### CITATION LIST

### Patent Literature

### PTL 1

### Japanese Patent Application Laid-Open No. 2009-177350

### SUMMARY OF INVENTION

### Technical Problem

In a conventional apparatus, however, there is a problem in that, when downloading starts such that data of a defect portion having a large data size are downloaded first, it takes a long waiting time to finish the first downloading process of the defect portion having a large data size. As a result, a user feels as if he/she is kept waiting for a long time to finish downloading process of all the remaining defect portions, and this makes the user frustrated.

It is therefore an object of the present invention to provide a communication terminal apparatus and a content data receiving method capable of reducing a waiting time felt. by a user during download of a defect portion and capable of reducing user's frustration.

### Solution to Problem

A communication terminal apparatus of the present invention includes a reception section that receives content data via a broadcasting network, an analysis section that detects a plurality of defect portions of the received content data, and calculates data sizes of the defect portions, and a communication section that downloads data in the defect portions via a communication network different from the broadcasting network, based on the calculated data sizes of the defect portions.

A content data receiving method of the present invention for a communication terminal apparatus that receives content data via a broadcasting network and a communication network different from the broadcasting network, wherein the content data receiving method includes the steps of receiving the content data via the broadcasting network, detecting a plurality of defect portions of the received content data, and calculates data sizes of the defect portions, and downloading data in the defect portions via the communication network, based on the calculated data sizes of the defect portions.

### Advantageous Effects of invention

According to the present invention, a waiting time felt by a user can be reduced during download of a defect portion, and user's frustration can be reduced.

### BRIEF DESCRIPTION OF DRAWINGS

FIG. 1 is a block diagram illustrating a configuration of a communication terminal apparatus according to an embodiment of the present invention;

FIG. 2 illustrates a configuration of a multimedia broadcasting system according to the embodiment of the present invention;

FIG. 3 illustrates an example of display of a display section according to the embodiment of the present invention; and

FIG. 4 illustrates another example of display of the display section according to the embodiment of the present invention.

### DESCRIPTION OF EMBODIMENTS

An embodiment of the present invention will be hereinafter described in detail with reference to accompanying drawings.

### Embodiment

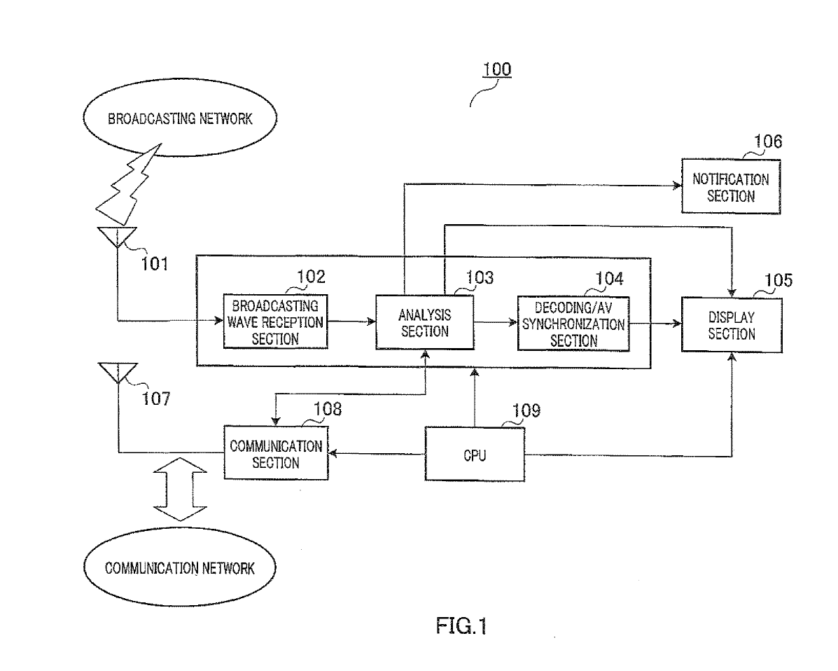

FIG. 1 is a block diagram illustrating a configuration of communication terminal apparatus 100 according to Embodiment 1.

Communication terminal apparatus 100 mainly includes antenna 101, broadcasting wave reception section 102, analysis section 103, decoding/AV synchronization section 104, display section 105, antenna 107, communication section 108, and CPU 109. Each configuration will be hereinafter described in detail.

Antenna 101 receives content data via a broadcasting network, and outputs the received content data to broadcasting wave reception section 102.

Broadcasting wave reception section 102 obtains content data by performing decoding processing on a reception signal received from antenna 101, and outputs the content data obtained from the decoding processing to analysis section 103.

Analysis section 103 analyzes control information attached to content data received from broadcasting wave reception section 102, and detects a plurality of defect portions. Analysis section 103 also calculates the data sizes of the detected defect portions. Analysis section 103 also obtains a decoding key from data for decoding the content received from communication section 108, and detects a valid period or an expiration date of the obtained decoding key. Analysis section 103 also analyzes the control information attached to the content data received from broadcasting wave reception section 102, and detects a valid period of the content or an expiration date of the content and the download speed of the content data. When a defect portion is detected, analysis section 103 requests communication section 108 to download data of the detected defect portion. At this occasion, for example, analysis section 103 requests downloading of data in such order that data in a defect portion having a small data size are downloaded first. For example, analysis section 103 requests downloading of data in such order that data in a defect portion of a content having a short valid period are downloaded first, or requests downloading of data in such order that data in a defect portion of a content having close expiration date are downloaded first. For example, analysis section 103 requests downloading in. the descending order of the download speed of content data. For example, analysis section 103 requests downloading of data in such order that data in a defect portion of a content decoded with a decoding key that has a short valid period are downloaded first, or requests downloading of data in such order that data in a defect portion of a content decoded with a decoding key that has a close expiration data are downloaded first. Analysis section 103 also outputs presence/absence of detected defect portion, the data size of the defect portion, the valid period or the expiration date of the content, the valid period or the expiration date of the decoding key, and the download speed of the content data to display section 105 as information about the content data. Analysis section 103 also outputs data of the defect portion received from communication section 108 and the content data received from broadcasting wave reception section 102, and the decoding key to decoding/AV synchronization section 104. Analysis section 103 also outputs the valid period or the expiration date of the content detected and the valid period or the expiration date of the decoding key to the notification section 106. For example, the decoding key is, for example, an encrypting key that allows only a predetermined user to decode the content data.

In this case, the valid period of a content is, for example, a period in which an address of the source from which the content is downloaded can be accessed, or a period in which the content already downloaded by communication terminal apparatus 100 can be viewed. The expiration date of the content is, for example, an expiration date by which an address of the source from which the content is downloaded can be accessed, or an expiration date by which the content already downloaded by communication terminal apparatus 100 can be viewed. The address of the source from which the content is downloaded is, for example, a storage location of the content identified by an URL (Uniform Resource Locator) or an URI (Uniform Resource Identifier). The valid period of the content is, for example, a remaining period (for example, the number of days or time) in which the content can be viewed. By setting this valid period, communication terminal apparatus 100 can disallow viewing the content that is no longer in the valid period. The expiration date of the content is, for example, an expiration date (for example, a day or a time) by which the content can be viewed. By setting this valid period, communication terminal apparatus 100 can disallow viewing the content that has passed the expiration date. The valid period of the decoding key is, for example, a remaining period (for example, the number of days or time) in which the content can be decoded. By setting this valid period, communication terminal apparatus 100 can disallow decoding of the content that is no longer in the valid period. The expiration date of the decoding key is, for example, an expiration date (for example, a day or a time) by which the content can be decoded. By setting this expiration date, communication terminal apparatus 100 can disallow decoding of the content that has passed the expiration date.

Decoding/AV synchronization section 104 decodes the content data and the defect data received from analysis section 103 using decoding key received from analysis section 103. Then, decoding/AV synchronization section 104 outputs the decoded content data to display section 105.

Display section 105 displays information about the content data received from decoding/AV synchronization section 104. At this occasion, for example, display section 105 preferentially displays information about content data having a defect portion of a small data size received from analysis section 103. For example, display section 105 preferentially displays information about content data having a short valid period received from analysis section 103, or preferentially displays information about content data having a close expiration date received from analysis section 103. For example, display section 105 preferentially displays information about content data having a high download speed received from analysis section 103. For example, display section 105 preferentially displays information about content data of a content decoded with a decoding key having a short valid period received from analysis section 103, or preferentially displays information about content data of a content decoded with a decoding key having a close expiration date received from analysis section 103.

Display section 105 also reproduces and displays a content received from decoding/AV synchronization section 104. A method for displaying information about content data will be described later in detail.

Notification section 106 compares the valid period of the content or the valid period of the decoding key received from analysis section 103 with a threshold value at a predetermined cycle. When the expiration date of the content or the expiration date of the decoding key is obtained from analysis section 103, notification section 106 obtains a valid period from the current point of time to the expiration date at a predetermined cycle, and compares the obtained valid period with a threshold value. Then, when the valid period of the content or the valid period of the decoding key becomes equal to or less than the threshold value, notification section 106 transmits a notification to the outside. For example, notification section 106 transmits a notification to the outside using vibration, sound, or light.

Antenna 107 transmits a signal for requesting download of data in a defect portion received from communication section 108. Antenna 107 also receives the data in the defect portion, and outputs the data to communication section 108. Antenna 107 performs transmission/reception via a communication network that is different from the broadcasting network such as a mobile telephone network, the Internet, or the like.

When communication section 108 receives a request of download of data in a defect portion from analysis section 103, communication section 108 generates a signal for requesting download of the data in the defect portion requested. Communication section 108 also outputs the generated signal for requesting the download to antenna 107. Communication section 108 downloads the data in the defect portion via antenna 107. Communication section 108 performs radio processing such as frequency conversion on the downloaded data in the defect portion, demodulates the data in the defect portion having received the radio processing, and outputs the data to analysis section 103. Communication section 108 also demodulates data for decoding the content received from antenna 107, and outputs the data to analysis section 103.

CPU 109 controls broadcasting wave reception section 102, analysis section 103, decoding/AV synchronization section 104, display section 105, and communication section 108.

The configuration of communication terminal apparatus 100 has been hereinabove described.

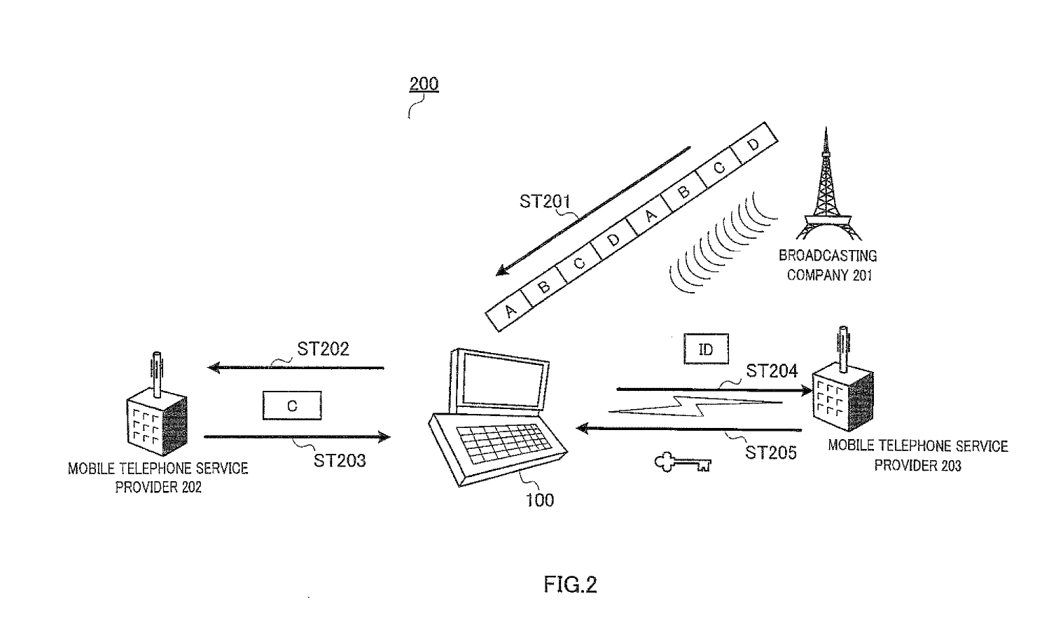

Subsequently, a method for receiving a content using a multimedia broadcasting system in communication terminal apparatus 100 will be described with reference to FIG. 2. FIG. 2 illustrates a method for receiving a content using multimedia broadcasting system 200.

First, communication terminal apparatus 100 receives content data via a broadcasting network from broadcasting company 201 providing real-time broadcasting service (step ST201). At this occasion, for example, broadcasting company 201 repeatedly transmits the content data “A”, “B”, “C”, “D” in order for a certain period of time. At this occasion, the content data are transmitted by a data carousel method.

Communication terminal apparatus 100 also causes analysis section 103 to detect whether the received content data includes a plurality of defect portions, and calculates the data sizes of the detected defect portions. Communication terminal apparatus 100 also causes analysis section 103 to analyze the control information attached to the content data, thereby detecting the valid period or the expiration date of the content. Communication terminal apparatus 100 also causes analysis section 103 to the control information attached to content data, thereby detecting the download speed of the content data. Communication terminal apparatus 100 also causes analysis section 103 to detect the valid period of the decoding key or the expiration date of the decoding key.

Communication terminal apparatus 100 also causes display section 105 to display the received information about content data. The information about content data is presence/absence of the above defect portion, the valid period of the content or the expiration date of the content, the valid period of the decoding key or the expiration date of the decoding key, the data size of the defect portions of the content data, or the download speed of the content data. A method for displaying information about content data with display section 105 will be described later in detail.

Subsequently, when there is a defect portion as a result of analysis, communication terminal apparatus 100 transmits a request of download of data in the defect portion to mobile telephone service provider 202 providing accumulation-type broadcasting service (step ST202). For example, when content data “C” are lost in the received content data, communication terminal apparatus 100 transmits a request of download of the content data “C” to mobile telephone service provider 202.

Subsequently, communication terminal apparatus 100 downloads the content data “C”, i.e., the defect portion via a communication network that is different from the broadcasting network (step ST203). A communication network used for downloading is, for example, a mobile telephone network. When the data in the defect portion is downloaded, communication terminal apparatus 100 causes display section 105 to continue to display the information about content data. By this means, by seeing the indication of display section 105 of communication terminal apparatus 100, a user can roughly find how much data in the defect portion have been downloaded. When a plurality of content data are received simultaneously, the download speed of each piece of content data is measured, and the information about content data with a fast download speed is preferentially displayed. This can reduce frustration of a user who monitors the download process on display section 105. In this case, “displaying preferentially” means, for example, displaying the data in an upper portion of display section 105.

Communication terminal apparatus 100 also authenticates a user with mobile telephone service provider 203 via a predetermined communication network (step ST204). Communication terminal apparatus 100 causes communication section 108 to obtain data far decoding content data from mobile telephone service provider 203 via the predetermined communication network and causes analysis section. 103 to obtain the decoding key (step ST205). In this case, the communication network with which user authentication is performed or the communication network used for obtaining the decoding key includes, for example, a mobile telephone network. The user authentication and the decoding key are also used during billing processing with respect to the content data obtained by communication terminal apparatus 100.

Subsequently, communication terminal apparatus 100 decodes the content data received via the broadcasting network and the downloaded data in the defect portion using the decoding key in decoding/AV synchronization section 104. For example, communication terminal apparatus 100 decodes the content data “A”, “B”, “D” received via the broadcasting network and the downloaded content data “C” in the defect portion.

Subsequently, communication terminal apparatus 100 causes display section 105 to display the content.

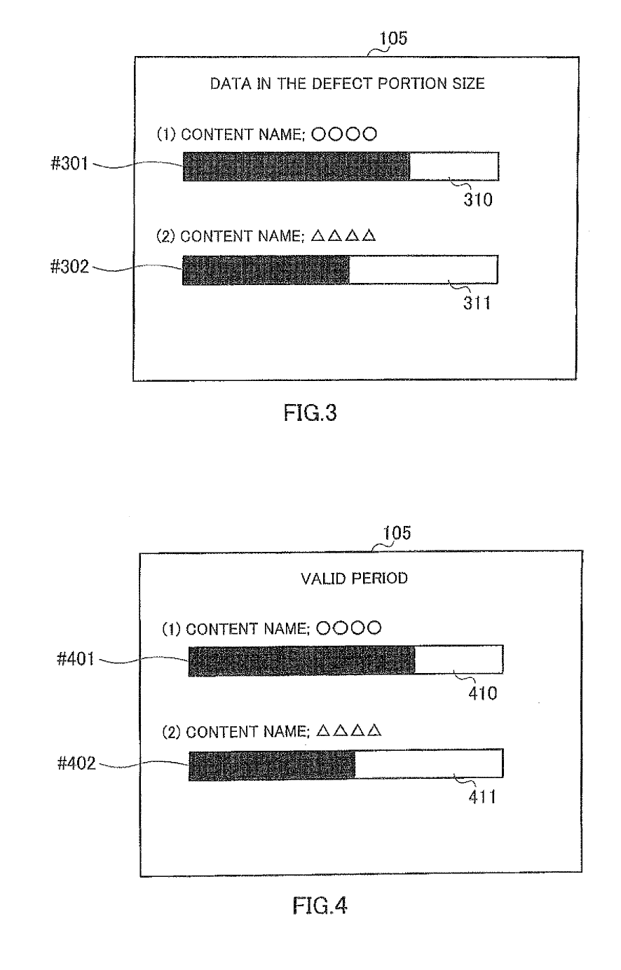

FIG. 3 illustrates an example of display of information about content data on display section 105.

As can be seen from FIG. 3, display section 105 displays presence/absence of defect portion as information about content data. Display section 105 also displays the data size of the data in the defect portion of the content data as the information about content data.

In other words, display section 105 displays presence/absence of the defect portion as outline portions 310, 311, and displays the data size of the data in the defect portion as horizontal lengths of outline portions 310, 311. At this occasion, the larger the data size of the defect portion is, the larger the horizontal length of the outline portion is. FIG. 3 shows a case where the data size of defect portion 310 of content data #301 is smaller than the data size of defect portion 311 of content data #302.

Display section 105 updates the display such that the sizes of areas of outline portions 310, 311 decrease as the defect portions decrease along with the downloading of the data in the defect portions.

Display section 105 preferentially displays information about content data of a defect portion having smaller data size. In FIG. 3, “displaying preferentially” means, for example, displaying the data in the defect portions in the ascending order of the data size when information about a plurality of pieces of content data are displayed in the same screen. In other words, information about content data to be displayed at a higher part of the screen indicates a higher degree of priority.

The data size of the data in the defect portion is not limited to the indication with outline. In addition to the indication with outline, a numerical value may be displayed in association with each piece of information about content data.

FIG. 4 illustrates another example of display of information about content data on display section 105.

As can be seen from FIG. 4, display section 105 displays the valid period or the expiration date of the content as information about content data. In other words, display section 105 displays the valid period or the expiration date as horizontal lengths of outline portions 410, 411. At this occasion, the longer the valid period is or the farther the expiration date is, the larger the horizontal length of the outline portion is. FIG. 4 shows a case where valid period 410 of the content of content data #401 is shorter than valid period 411 of the content of content data #402. FIG. 4 also shows a case where the expiration date of the content of content data #401 is closer than the expiration date of the content of content data #402.

Display section 105 preferentially displays information about content data of a content having a short valid period, or preferentially displays information about content data of a content having a closer expiration date. In FIG. 4, “displaying preferentially” means, for example, displaying information about content data of contents in the ascending order of the valid period or information about content data of contents in the ascending order of the expiration date, when information about a plurality of pieces of content data are displayed on a same screen. In other words, information about content data displayed at a higher part of the screen indicates a higher degree of priority.

The indication of the valid period or the expiration date is not limited to the indication with outline as shown in FIG. 4. In addition to the indication with outline, a numerical value may be displayed in association with each piece of information about content data, Even when the valid period or the expiration date of the decoding key or the download speed of the content data is displayed as information about content data, it can be displayed as shown in FIG. 3 or FIG. 4.

In the above explanation, communication terminal apparatus 100 detects the valid period or the expiration date of the content by analyzing the content data received from the broadcasting company via the broadcasting network. Alternatively, communication terminal apparatus 100 may detect the valid period or the expiration date of the content by analyzing data received from the mobile telephone service provider via the mobile telephone network or the Internet. In other words, in a multimedia broadcasting service such as ISDB-Tmm, the broadcasting company and the mobile telephone service provider can transmit content data of the same content, Therefore, like the broadcasting company, the mobile telephone service provider can attach information about the valid period or the expiration date to content data to be transmitted. In this case, communication terminal apparatus 100 can update the valid period or the expiration date obtained by analyzing content data received from the broadcasting company using the valid period or the expiration date obtained by analyzing data received from the mobile telephone service provider.

As described above, according to the present embodiment, when a defect occurs in content data obtained from the real-time broadcasting service, a waiting time felt by a user can be reduced during download of a defect portion, and user's frustration can be reduced. In addition, according to the present embodiment, the defect portions are downloaded in the ascending order of the data size, and therefore, a larger number of contents can he downloaded within a predetermined period of time. In other words, as a result of downloading data in the defect portion having a large data size first, this can prevent taking much time in downloading data in the defect portion having a large data size and increasing the waiting time until the data in the other defect portions starts to be downloaded, In addition, according to the present embodiment, defect portions of content data of contents are downloaded in the ascending order of the valid period, or defect portions of content data of contents are downloaded in the ascending order of the expiration date. As a result, the data in the defect portions of contents can be downloaded in the ascending order of the viewable period, and this can reliably ensure margin for viewing the contents in terms of time. In addition, according to the present embodiment, defect portions of content data of contents arc downloaded in the ascending order of the valid period of the decoding key with which the content is decoded, or defect portions of content data of contents are downloaded in the ascending order of the expiration date of the decoding key with which the content is decoded. Therefore, the data in the defect portions of contents can be downloaded in the ascending order of the decodable period, and this can reliably ensure margin for decoding the contents in terms of time. In addition, according to the present embodiment, a notification is given when the valid period of the content or the valid period of the decoding key is short or the expiration date of the content or the expiration date of the decoding key approaches. Therefore, this can prevent failing to view a content without letting a user know the failure.

In the present embodiment, the order in which the defect portions are downloaded is determined according to the data size and the like of the data in the defect portion. However, the present invention is not limited thereto. Alternatively, the order in which the defect portions are downloaded may be determined according those other than to the data size and the like. For example, the defect portions may be preferentially downloaded in the descending order of the amount of accumulation of content data accumulated in the communication terminal apparatus, the number of views of the genre of the content, or the bit rate during the download. In the present embodiment, a notification is given using vibration, sound, or light to inform that the valid period is short or the expiration date is close. However, the present invention is not limited thereto. Alternatively, the display section may inform using a highlight indication and the like. In this ease, analysis section 103 can give the above notification by outputting information about content data to display section 105. In addition, in the present embodiment, analysis section 103 obtains the data size of data in the defect portion, the valid period or the expiration date of the content, the valid period or the expiration date of the decoding key, and the download speed of the content data. However, the present invention is not limited thereto. Alternatively, analysis section 103 may obtain, as necessary, one or a plurality of the data size of data in the defect portion, the valid period or the expiration date of the content, the valid period or the expiration date of the decoding key, and the download speed of the content data.

The contents of disclosure of the specification, the drawings, and the abstract included in the Japanese Patent Application No. 2009-250426 filed on Oct. 30, 2009, are all incorporated herein by reference.

### INDUSTRIAL APPLICABILITY

The present invention is suitable for a communication terminal apparatus and a content data receiving method for receiving content data according to ISDB-Tram method, for example.

1-10. (canceled)

11. A communication terminal apparatus comprising: a reception section that receives content data via a broadcasting network;
an analysis section that detects a defect portion of the received content data, and calculates a data size of the defect portion; and
a communication section that downloads data in the defect portion via a communication network different from the broadcasting network, based on the calculated data size of the defect portion.

12. The communication terminal apparatus according to claim 11, wherein the communication section downloads the data in the defect portion in ascending order of the data size calculated by the analysis section.

13. The communication terminal apparatus according to claim 11 further comprising a display section, wherein when information about a plurality of pieces of the content data received by the reception section are displayed on a same screen, the display section preferentially displays the information about a piece of the content data including the defect portion of which data size calculated by the analysis section is small.

14. The communication terminal apparatus according to claim 11 further comprising a display section that displays, on a same screen, information about a plurality of pieces of the content data received, by the reception section,
wherein the analysis section not only calculates the data sizes but also detects a valid period of a content by analyzing the plurality of pieces of the content data received by the reception section, and
the display section preferentially displays information about a piece of the content data of a content having a short valid period.

15. The communication terminal apparatus according to claim 11 further comprising a display section that displays, on a same screen, information about a plurality of pieces of the content data received by the reception section,
wherein the analysis section not only calculates the data sizes but also detects a download speed of content data by analyzing the plurality of pieces of the content data received by the reception section, and
the display section preferentially displays information about a piece of the content data of which download speed is fast.

16. The communication terminal apparatus according to claim 11 further comprising a display section that displays, on a same screen, information about a plurality of pieces of the content data received by the reception section,
wherein the analysis section not only calculates the data sizes but also obtains a decoding key for decoding a content and detects a valid period of the decoding key, and
the display section preferentially displays information about a piece of the content data of a content of the decoding key having short valid period.

17. The communication terminal apparatus according to claim 11 further comprising a display section that displays, on a same screen, information about a plurality of pieces of the content data received by the reception section,
wherein the analysis section not only calculates the data sizes but also obtains a decoding key for decoding a content and detects an expiration date of the decoding key, and
the display section preferentially displays information about a piece of the content data of a content of the decoding key having close expiration date.

18. A content data receiving method for a communication terminal apparatus that receives content data via a broadcasting network and a communication network different from the broadcasting network, the content data receiving method comprising the steps of:
receiving the content data via the broadcasting network;
detecting a defect portion of the received content data, and calculates data size of the defect portion; and
downloading data in the defect portion via the communication network, based on the calculated data size of the defect portion.
